(19) United States
(12) Patent Application Publication
(10) Pub. No.: US 2005/0201391 A1
(43) Pub. Date: Sep. 15, 2005

(54) NETWORK ADDRESS TRANSLATION ROUTER AND RELATED METHOD

(76) Inventors: Hung-Fang Ma, Hsin-Chu Hsien (TW); Pau-Chuan Ting, Tai-Chung Hsien (TW); Kuo-Chung Yu, Tao-Yuan Hsien (TW); Lun-Jung Wang, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,554

(22) Filed: Mar. 11, 2004

(51) Int. Cl. H04L 12/56

(52) U.S. Cl. 370/401

(57) ABSTRACT

A network address translation (NAT)-enabled device such as a router or gateway device includes a NAT facility for connecting at least two hosts inside a first network to a second network allowing the inside hosts to share an address of the second network, a gateway interface for connecting to a demilitarized zone (DMZ) host inside the first network, a disposer connected to the gateway interface for assigning an address of the second network to the DMZ host, and a dispatcher connected to the gateway interface and the NAT facility for communicating messages between the second network and the gateway interface or the NAT facility according to a medium access control (MAC) address of the message.

### BACKGROUND OF INVENTION

1. Field of the Invention

The present invention relates to networks and, more particularly, to communication across NAT-enabled devices.

2. Description of the Prior Art

Network address translation (NAT) is one technique that provides secure connectivity for a group of computers or devices on a private network to a group of computers or devices on public networks such as the Internet. NAT technology allows requests to be made from inside to outside of a network, but blocks requests initiated from the outside. The essentiality is that computers or devices inside the NAT facility cannot be contacted or queried.

Accordingly, NAT technology automatically provides fire-wall-style protection for devices behind a NAT-enabled device (such as a router, gateway device, or the like) without any special setup. This is because NAT functionality blocks communication from non-standard ports and masquerades Internet protocol (IP) addresses of the devices behind a NAT-enabled device. With port blocking, only devices on the inside of the private network are allowed to initiate a connection to the outside. IP masquerading hides the private IP addresses of the devices inside, thereby keeping them anonymous to the outside.

Existing techniques that allow outside devices to communicate with inside devices through NAT-enabled devices have a number of disadvantages. Typically, to use nonstandard ports and allow incoming traffic, a port-redirection technique is used. In port-redirection, a NAT-enabled device may appoint a port number on behalf of an inside host and announce this port number to the outside world. For any incoming traffic, if its destination address is targeted to the NAT-enabled device and the port number matches the announced number, the NAT-enabled device will redirect it to such an inside host. However, for some applications running on the inside host, the address information and port number of messages sent from this inside host are hidden in message content, resulting in port redirection not working properly. To work around address information being hidden in message content, the NAT-enabled device needs to thoroughly inspect the contents of all incoming messages, resulting in significant reduction in performance. Furthermore, for many applications with undocumented address and port information hidden in message content, NAT-enabled devices are unable to translate or redirect the address and/or port correctly using prior art methods.

Therefore, there is a need for an efficient technique to provide communication across NAT-enabled devices.

### SUMMARY OF INVENTION

It is therefore a primary objective of the claimed invention to provide a NAT-enabled device, gateway device, or router and related method for communicating information between two networks to solve that above mentioned problems.

Briefly summarized, one embodiment of the claimed invention includes a NAT facility for connecting at least two hosts inside a first network to a second network allowing the inside hosts to share an address of the second network, a gateway interface for connecting to a demilitarized zone (DMZ) host inside the first network, a disposer connected to the gateway interface for assigning an address of the second network to the DMZ host, and a dispatcher connected to the gateway interface and the NAT facility for communicating messages between the second network and the gateway interface or the NAT facility according to a communication criteria of the message.

The claimed invention offers at least the following advantages. First, since the DMZ host (or True-IP DMZ host) has the same public IP address as a wide area network (WAN) port in the NAT-enabled device, it is not necessary for the NAT-enabled device to resolve the address information contained in the content (or payload) of the message intended for the True-IP DMZ host. As a result, applications running on the True-IP DMZ host can communicate smoothly and without difficulty with external hosts in the second network. Second, there may be a significant reduction of the processing time in the NAT-enabled device to examine the address information contained in the message intended for the True-IP DMZ host. Third, for many applications with undocumented address and port information hidden in message content, prior art NAT-enabled devices are unable to translate or redirect the address and/or port correctly. The claimed invention True-IP DMZ is a novel solution that allows the internal DMZ host to run those types of applications.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a network system according to one embodiment of the present invention.

FIG. 2 is a block diagram of the NAT-enabled device shown in FIG. 1 according to one embodiment of the present invention.

FIG. 3 is a state machine diagram illustrating a state “Idle”.

FIG. 4 is a state machine diagram illustrating a state “Active_P”.

FIG. 5 is a state machine diagram illustrating a state “Active”.

FIG. 6 is a state machine diagram illustrating a state “DMZ Linking”.

FIG. 7 is a state machine diagram illustrating a state “WAN Linking”.

FIG. 8 is a state machine diagram illustrating a state “Ready”.

### DETAILED DESCRIPTION

In the following description, for purposes of explanation, numerous details are set forth in order to provide a thorough understanding of the present invention. However, it will be apparent to one skilled in the art that these specific details are not required in order to practice the present invention. In other instances, well-known structures are shown in block diagram or flowchart form in order not to obscure the present invention.

The present invention provides a device and technique to allow efficient communication across network address translation (NAT)-enabled devices. In one embodiment, a True Internet protocol (IP)demilitarized zone (DMZ) scheme embedded in a NAT-enabled device accommodates an inside DMZ host. The True-IP DMZ scheme establishes a convenience connection between the inside DMZ host and an outside host by assigning the public wide area network (WAN) IP address to the internal DMZ host and dispatching messages to it without examining the routing information contained in message content.

In one embodiment of the invention, a True-IP DMZ scheme includes a gateway interface, a disposer, and a dispatcher. The gateway interface is internal to a NAT-enabled device and interfaces with a DMZ host inside the network served by the NAT-enabled device. The DMZ host is any host placed in the DMZ of the NAT-enabled device or the firewall. The disposer deals with all requests from the internal DMZ host and assigns the public WAN IP address to the internal DMZ host. For ease of explanation, in the following, we call such an internal DMZ host having a public IP address identical to the NAT-enabled device's WAN IP address a True-IP DMZ host, a DMZ host, or an internal/inside host. The dispatcher collects messages transmitted by an external host outside the NAT-enabled device controlled network and intended for the True-IP DMZ host, and then forwards them to the True-IP DMZ host.

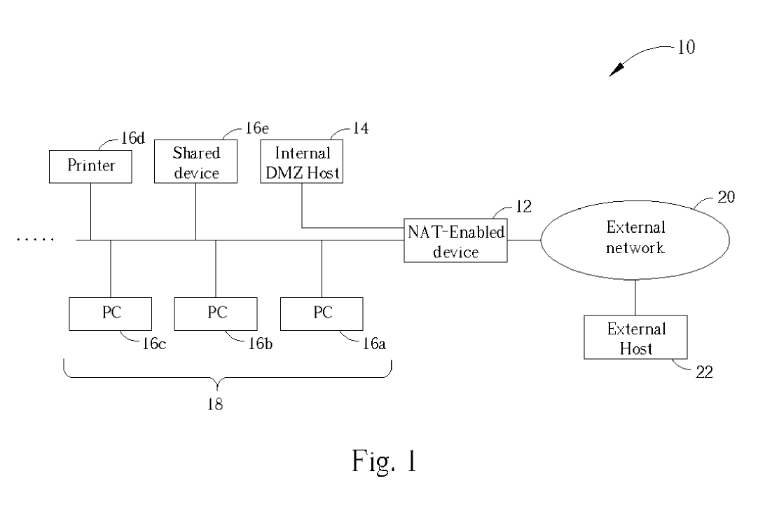

FIG. 1 is an exemplary diagram illustrating a network system 10 in which one embodiment of the invention can be practiced. The system includes a NAT-enabled device 12; an internal DMZ host 14; a plurality of computers or hosts 16a-c, a printer 16d, and another shared device 16e(a network scanner, copier, etc.) forming a network (first network) 18 served by the NAT-enabled device 12; an external network (second network) 20; and an exemplary external host 22 (more than one is typical). Further, in this system 10, the True-IP DMZ scheme according to the present invention is implemented in the NAT-enabled device 12 and the internal DMZ host 14 represents the True-IP DMZ host previously described.

The external host 22 is any device, equipment, or computer that is located outside the network 18 and has a connection to the NAT-enabled device 12 via a pathway, such as the external network 20, such that it can communicate with the True-IP DMZ host 14. The external network 20 is any network of devices, equipment, or computers having networking functionality. The external network 20 may be a local area network (LAN), a WAN, or the Internet.

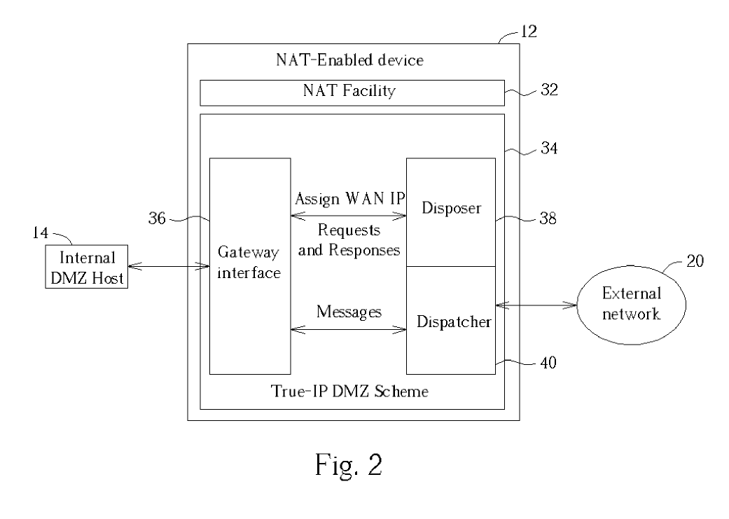

Generally, the NAT-enabled device 12 is situated between the internal network 18 and the external world (network 20, for instance the Internet), and as such the present invention applies to any gateway device that employs NAT technology. Although the term “device” is used, the NAT-enabled device 12 may be a physical device, equipment, computer, software program, program module, or any combination of these. In this embodiment, the NAT-enabled device 12 includes at least a NAT facility and a True-IP DMZ scheme (discussed later with reference to FIG. 2).

The NAT facility in the NAT-enabled device 12 offers a main benefit for all inside hosts 16a-c to share a public IP address for connecting to the external network 20. That is, sharing one IP address recognized by the external network 20, all inside hosts 16a-16c can access the external network 20 as if they each had an IP address. In addition, the NAT facility also hides the IP addresses of all inside hosts 16a-c behind the NAT-enabled device 12 from the outside world and automatically offers a firewall-style protection for them without any special setup.

The True-IP DMZ scheme allows efficient communication across the NAT-enabled device 12. Essentially, the True-IP DMZ scheme embedded in the NAT-enabled device 12 allows the internal DMZ host 14 to establish a convenience connection to the external host 22 through the network 20. This is achieved by assigning the public WAN IP address to the internal DMZ host 14 and dispatching the message to it without examining any routing information contained in the message content. According to the present invention, the True-IP DMZ scheme may be implemented by hardware, software, or any combination of hardware and software.

The internal DMZ host 14 is any device, equipment, or computer located inside the network 18 or inside the NAT-enabled device 12. The DMZ host 14 is established by the NAT-enabled device 12 selecting a suitable internal host after adequately setting the configuration of the NAT-enabled device 12 through web user interface, command line interface, or a combination of such. The internal DMZ host 14 receives its own IP address from the NAT-enabled device 12 for external communication with the outside devices. Particularly, its IP address should be public and identical to the wide area network (WAN) IP address of the NAT-enabled device 12. Accordingly, such an internal DMZ host becomes the True-IP DMZ host and thus is able to send/receive messages to/from the outside hosts directly via the True-IP DMZ scheme in the NAT-enabled device 12.

FIG. 2 is an exemplary block diagram illustrating the NAT-enabled device 12 shown in FIG. 1 according to one embodiment of the present invention. The NAT-enabled device 12 includes a NAT facility 32 and a True-IP DMZ scheme 34. The True-IP DMZ scheme 34 includes a gateway interface 36, a disposer 38, and a dispatcher 40. The True-IP DMZ scheme 34 may be implemented including more or less than the above components, and by a combination of two or more components. The gateway interface 36, the disposer 38, and the dispatcher 40 may each be implemented by software, a program, a module, a microcode routine, a function, or any combination thereof.

The gateway interface 36 interfaces with the True-IP DMZ host 14. When required, the gateway interface 36 establishes a connection between the True-IP DMZ host 14 and the external host (such external host 22 of FIG. 1) outside the network served by NAT-enabled device 12. The gateway interface 36 is also responsible for determining whether the WAN link in the NAT-enabled device 12 is active and whether its associated WAN IP address is public or not such that the True-IP DMZ host 14 according to the present invention can operate properly. If the NAT-enabled device 12 does not have the WAN IP address, the gateway interface 36 will trigger the NAT-enabled device 12 to make a WAN connection and to acquire a WAN IP address.

The disposer 38 deals with all requests from the True-IP DMZ host 14 so that the True-IP DMZ host 14 can smoothly obtain its IP address, acquire a lifetime to transmit messages, get information about locations of other hosts, and perform other requests and responses. Requests may include a dynamic host configuration protocol (DHCP) request and an address resolution protocol (ARP) request. Upon receiving the DHCP request from the True-IP DMZ host 14, the disposer 38 will assign the public WAN IP address of the NAT-enabled device 12 and the granted transmission lifetime to the True-IP DMZ host 14 via the DHCP reply. However, if the WAN IP address of the NAT-enabled device 12 is not public, either because its WAN link is not active or its WAN IP address from an Internet Provider is private, the disposer 38 will assign a temporary private IP address and associated lifetime time to the True-IP DMZ host 14 in response to a DHCP request from the True-IP DMZ host 14.

The dispatcher 40 collects messages that are sent by external hosts connected to the external network 20 and in-tended for the True-IP DMZ host 14. The dispatcher 40 then forwards the collected messages to the True-IP DMZ host 14 if there is a match in the address information of the message. If there is no address match, either because the message is forged or the IP address of the True-IP DMZ host is changed at this moment, the message will be discarded. The dispatcher 40 records the address information of the True-IP DMZ host 14 inside the NAT-enabled device 12. The recorded address information will be compared with the destination address information of messages received by the dispatcher 40 such that a decision to forward the message can be made. Since the IP address of the True-IP DMZ host 14 is identical to the WAN IP address of the NAT-enabled device 12, the dispatcher 40 can use a communication criteria such as the destination medium access control (MAC) address of messages received from the outside world to specifically identify the True-IP DMZ host 14. That is, the dispatcher 40 references information in the MAC address of a message to determine if the message is supposed to undergo normal processing at the NAT facility 32 of the NAT-enabled device 12 (i.e. the message destination is a device 16a-e of FIG. 1) or if the message is to be simply forwarded to the True-IP DMZ host 14. Similarly, the dispatcher 40 can also collect messages from the True-IP DMZ host 14 by checking the source MAC address of a message to identify the True-IP DMZ host 14.

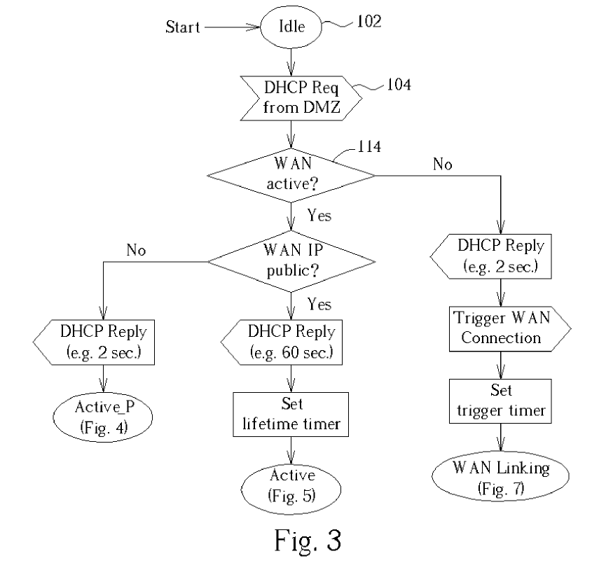

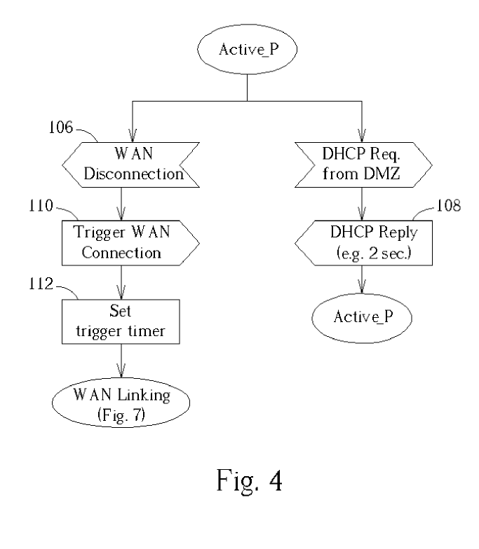

FIGS. 3-8 are exemplary state machine diagrams illustrating the assignment of the WAN IP address to the True-IP DMZ host 14 shown in FIG. 2. In FIGS. 3-8, the state machine has six states: “Idle”, “Active”, “Active_P”, “DMZ linking”, “WAN linking”, and “Ready”, respectively. States are illustrated as a circle, symbol type 102 (FIG. 3) being representative (i.e. all circles in FIG. 3-8 represent states). Each state is impelled by events so that the present invention moves to subsequent actions. Events triggered by the True-IP DMZ host 14 are represented by the symbol type 104 (FIG. 3).Symbol type 106 (FIG. 4) characterizes another type of event which is triggered by an external host such as host 22.Symbol type 108 (FIG. 4) identifies a message to the True-IP DMZ host 14 and symbol type 110 (FIG. 4)identifies a message to an external host. Symbol type 112 (FIG. 4) denotes unconditional executable actions, for instance setting a specific timer, and symbol type 114 (FIG. 3)indicates a decision based on the prespecified condition (i.e. “If” statements). Please note that for the sake of succinctness in FIGS. 3-8 the abbreviations defined above (DHCP, WAN, etc.) are used along with the abbreviation “Req.” meaning request.

Referring to FIG. 3, upon START, the True-IP DMZ scheme according to the present invention stays at the “Idle” state and waits for a DHCP request from the True-IP DMZ host 14. The invention may check the source MAC address of received DHCP requests to identify the True-IP DMZ host 14. Before proceeding, the NAT-enabled device 12 is triggered to make a WAN connection and to acquire a WAN IP address. If the WAN connection is not active, the NAT-enabled device 12 will be triggered once again to make a WAN connection and to acquire a WAN IP address. In the meantime, the state machine assigns a private IP address and a temporary IP's validity lifetime to the True-IP DMZ host 14 in response to a DHCP request from True-IP DMZ host 14. The validity lifetime for a temporary IP may be as short as, for example, two seconds. Next, the state machine goes into the “WAN Linking” state. If the WAN connection is active, the state machine has to further check whether the acquired WAN IP address is public or private. In the case of a private WAN IP address, the state machine appoints a private IP address and a temporary IP's validity lifetime, e.g.two seconds, to the True-IP DMZ host 14 via a DHCP reply. Afterward, the state machine enters into the “Active_P” state. In the case of the public WAN IP address, the state machine assigns the WAN IP address of the NAT-enabled device 12 and the associated lifetime to the True-IP DMZ host 14 via a DHCP reply. The IP's lifetime could be set as, for example, 60 seconds. Subsequently, the lifetime timer is restarted for countdown and the state machine enters into the “Active” state.

Referring to FIG. 4, entering the “Active_P” state represents that the invention has made a WAN connection but acquired a private WAN IP address. In the “Active_P” state, the state machine may either receive a DHCP request from the True-IP DMZ host 14 or suffer from a broken WAN connection. The former event results in the assignment of a private IP address and a temporary IP's validity lifetime to the True-IP DMZ host 14 via a DHCP reply. The validity lifetime for a temporary IP may be as short as, for example, 2 seconds. Then, the state machine returns back to the “Active_P” state. The latter event, i.e. suffering a broken WAN connection, stimulates the present invention to trigger a WAN connection and to acquire a WAN IP address again. Afterward, the state machine sets the trigger timer for countdown and goes into the “WAN Linking” state.

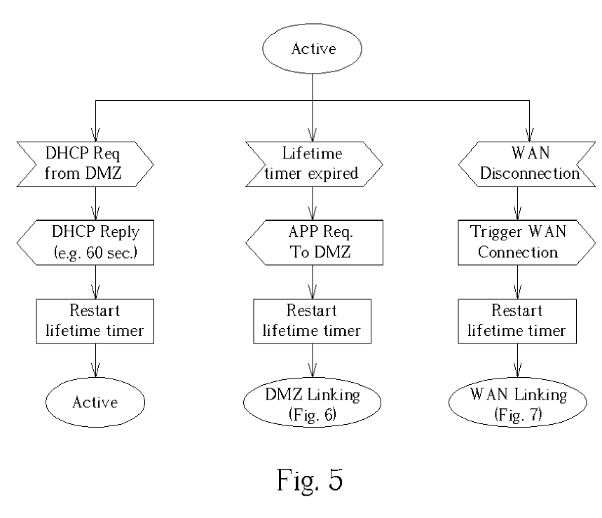

Referring to FIG. 5, as the public WAN IP address is successfully assigned to the True-IP DMZ host 14, the state machine enters the “Active” state, representing that the True-IP DMZ scheme operates properly on behalf of the True-IP DMZ host 14 to establish a convenience connection between the True-IP DMZ host 14 and the outside host 22. In the “Active” state, the state machine may receive a DHCP request from the True-IP DMZ host 14, experience the expiration of the lifetime timer, or suffer from a broken WAN connection. In the event of receiving a DHCP request from the True-IP DMZ host, the invention continuously assigns the WAN IP address of the NAT-enabled device 12 and associated lifetime to the True-IP DMZ host 14 via a DHCP reply. The lifetime timer could be set as, for example, 60 seconds. Subsequently, the lifetime timer is restarted for countdown and the state machine enters into the “Active” state once again. In the case of expiration of the lifetime timer, either because the True-IP DMZ host 14 is inactive a long time or the DMZ connection (the connection between the True-IP DMZ host 14 and the True-IP DMZ scheme 34) is broken, the present invention will send an ARP request to the True-IP DMZ host 14 in an attempt to probe its status. Subsequently, the state machine restarts the lifetime timer and goes into the “DMZ Linking” state. If the event of a broken WAN connection occurs first, the state machine will be triggered to make a WAN connection and to acquire a WAN IP address. Next, the state machine restarts the trigger timer for countdown and goes into the “WAN Linking” state.

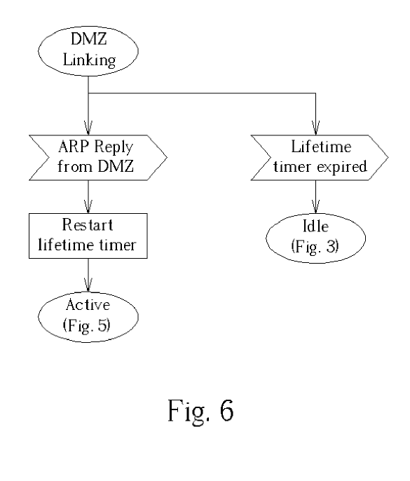

Referring to FIG. 6, the “DMZ Linking” state allows the present invention to determine the status of the True-IP DMZ host 14 by sending an ARP request to it. If an ARP reply from the True-IP DMZ host 14 is received, the present invention restarts the lifetime timer and enters into the “Active” state. If the lifetime timer expires first, the invention goes into the “Idle” state immediately.

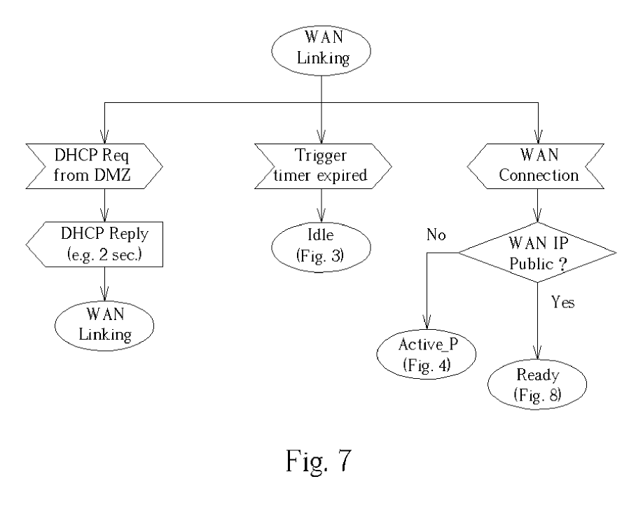

Referring to FIG. 7, the “WAN Linking” state indicates that the invention waits for the NAT-enabled device to make a WAN connection and to acquire a WAN IP address. When the WAN connection is made, the present invention True-IP DMZ scheme is triggered to verify whether the acquired WAN IP address is public or private in order to determine which state the state machine will move to next. In the case of the public WAN IP address, the state machine moves to the “Ready” state. Otherwise, it enters into the “Active_P” state. Before the WAN connection is made, the invention may receive a DHCP request from the True-IP DMZ host 14. In this case, the invention will assign a private IP address and a temporary IP's validity lifetime to the True-IP DMZ host 14 via a DHCP reply and then return back to the “WAN Linking” state. The lifetime for a temporary IP may be as short as, for example, two seconds. Also, it is possible that the trigger timer expires first to stimulate the invention to enter into the “Idle” state immediately.

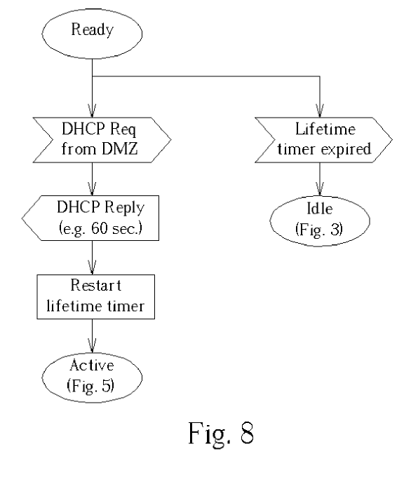

Finally, referring to FIG. 8, in the “Ready” state, the present invention may either receive a DHCP request from the True-IP DMZ host 14 or experience the expiration of the lifetime timer. If the lifetime timer expires, the invention will go into the “Idle” state immediately. If another event occurs first, the WAN IP address of the NAT-enabled device 12 and associated validity lifetime will be assigned to the True-IP DMZ host 14 in response to the received DHCP request, and the lifetime timer will be reset. The validity time, for example, may be 60 seconds. Subsequently, the invention goes into the “Active” state.

Regarding the preceding description of the state machine according to the present invention, it is noted that the invention may be described as a process that is usually depicted as a flowchart, a flow diagram, a block diagram, a state machine, or a state transition diagram. Although a flow diagram may describe the operations as a sequential process, many of operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. Moreover, the specific times suggested are merely examples and suitable times other than two or 60 seconds can also be used.

The present invention device and method may be implemented by software, firmware, microcode, or any combination thereof. The implemented elements of the present invention are the program code or code segments to perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, data, arguments, parameters, etc. may be passed, forwarded, or transmitted via any suitable means including memory sharing, message passing, network transmission, etc. Program or code segments may be stored in a processor readable medium or transmitted by a computer data signal embodied in a carrier wave over a transmission medium. A processor readable medium may include any medium that can store or transfer information. Examples of processor readable media include a semiconductor memory device, a read-only memory (ROM), a flash memory, an erasable ROM (EROM), a fiber optic medium, etc. Computer data signals may include any signal that can propagate over a transmission medium such as electronic network channels, optical fibers, etc. Code segments may be downloaded via computer networks such as the Internet, an intranet, etc.

The present invention NAT-enabled device and method offers at least the following advantages. First, since the DMZ host 14 has the same public IP address as a WAN port in the NAT-enabled device 12, it is not necessary for the NAT-enabled device 12 to resolve the address information contained in the content (or payload) of the message intended for the True-IP DMZ host 14. As a result, applications running on the True-IP DMZ host 14 can communicate freely with external hosts in the external network 20. Second, there may be a significant reduction of the processing time in the NAT-enabled device 12 to examine the address information contained in messages intended for the True-IP DMZ host 14. Third, for many applications with undocumented address and port information hidden in message content, the True-IP DMZ scheme according to the present invention allows the internal DMZ host 14 to run those types of applications. Thus, the present invention allows efficient communication across NAT-enabled devices and networks.

Those skilled in the art will readily observe that numerous modifications and alterations of the device may be made while retaining the teachings of the invention. Accordingly, the above disclosure should be construed as limited only by the metes and bounds of the appended claims.

1. A network address translation (NAT)-enabled device comprising:
a NAT facility for connecting at least two hosts inside a first network to a second network, wherein the NAT facility allows the inside hosts to share an address of the second network;
a gateway interface for connecting to a demilitarized zone (DMZ) host inside the first network;
a disposer connected to the gateway interface for assigning an address of the second network to the DMZ host; and
a dispatcher connected to the gateway interface and the NAT facility for communicating messages between the second network and the gateway interface or the NAT facility according to a communication criteria of the message.

2. The NAT-enabled device of claim 1 wherein the communication criteria is derived from a medium access control (MAC) address of the message.

3. The NAT-enabled device of claim 2 wherein the disposer assigns the second network address of the NAT-enabled device to the DMZ host if such address is public.

4. The NAT-enabled device of claim 3 wherein the disposer assigns a temporary second network address and associated validity lifetime to the DMZ host if the second address of the NAT-enabled device is not public.

5. The NAT-enabled device of claim 4 wherein the disposer assigns an address to the DMZ host in response to a request from the DMZ host.

6. The NAT-enabled device of claim 5 wherein the disposer allows the DMZ host to acquire a validity lifetime to transmit messages or obtain addresses of hosts in the second network upon a request by the DMZ host.

7. The NAT-enabled device of claim 2 wherein the dispatcher stores the address of the DMZ host and compares destination address information of a message received from the second network with the address of the DMZ host, forwarding the message to the DMZ host when the MAC address corresponds to the DMZ host and forwarding the message to the NAT facility when the MAC address does not correspond to the DMZ host.

8. The NAT-enabled device of claim 7 wherein the dispatcher identifies a message being sent to the second network from the DMZ host by checking the MAC address of such message.

9. A network address translation (NAT)-enabled device comprising:
a NAT facility for connecting at least two hosts inside a first network to a second network, wherein the NAT facility allows the inside hosts to share an address of the second network;
a gateway interface for connecting to a demilitarized zone (DMZ) host inside the first network;
a disposer connected to the gateway interface for assigning an address of the second network to the DMZ host in response to a request from the DMZ host, wherein the disposer assigns the second network address of the NAT-enabled device to the DMZ host if such address is public and the disposer assigns a temporary second network address and associated validity lifetime to the DMZ host if the second address of the NAT-enabled device is not public; and
a dispatcher connected to the gateway interface and the NAT facility for communicating messages between the second network and the gateway interface or the NAT facility according to a communication criteria of the message, the dispatcher storing the address of the DMZ host and comparing destination address information of a message received from the second network with the address of the DMZ host, and forwarding the message to the DMZ host when the communication criteria corresponds to the DMZ host and forwarding the message to the NAT facility when the communication criteria does not correspond to the DMZ host, the dispatcher identifying a message being sent to the second network from the DMZ host by checking the communication criteria of such message.

10. The NAT-enabled device of claim 9 wherein the communication criteria is derived from a medium access control (MAC) address of the message.

11. The NAT-enabled device of claim 10 wherein the disposer allows the DMZ host to acquire a validity lifetime to transmit messages or obtain addresses of hosts in the second network upon a request by the DMZ host.

12. A method for communicating information between a first network and a second network, the method comprising:
assigning a second network address to a demilitarized zone (DMZ) host of the first network;
receiving from the second network a message having a destination address equal to the second network address;
forwarding the message to the DMZ host of the first network when a communication criteria of the message matches a first criteria; and
forwarding the message to another host of the first network when the communication criteria of the message does not match criteria.

13. The method of claim 12 wherein the second network address assigned to the DMZ host is the second network address of the first network when such address is public, and the second network address assigned to the DMZ host is a temporary second network address when the second network address of the first network is not public.

14. The method of claim 13 wherein the communication criteria is derived from a medium access control (MAC) address of the message, the first criteria being the MAC address of the DMZ host.

15. The method of claim 14 wherein the temporary second network address has a validity lifetime considerably shorter than that of the second network address of the first network.

16. The method of claim 15 further comprising:
reassigning a second network address to a demilitarized zone (DMZ) host of the first network upon expiry of the validity lifetime.

17. The method of claim 16 further comprising:
detecting for an active connection between the first and second networks;
activating a connection between the first and second networks when no connection between the first and second networks exists.

18. The method of claim 14 wherein assigning the second network address to the DMZ host is in response to a request from the DMZ host.

19. A network address translation (NAT)-enabled device, gateway device, or network router comprising a NAT facility, a gateway interface, a disposer, and a dispatcher for performing the method of claim 12.
